(19) United States
(12) Patent Application Publication
(10) Pub. No.: US 2004/0201200 A1
(43) Pub. Date: Oct. 14, 2004

(54) Can hitch

(76) Inventor: Don Ahlquist, Gull Lake (CA)

Correspondence Address: Don Ahlquist, P.O. Box 34,RR1 SUITE 2, LACOMER, AB, T4L2N1, CA

(21) Appl. No.: 10/412,415

(22) Filed: Apr. 14, 2003

(51) Int. Cl. B60D 1/00

(52) U.S. Cl. 280/477

(57) ABSTRACT

An apparatus and method to facilitate the connection and disconnection of a towed vehicle (trailer, implement of husbandry, sled, industrial conveyance, etc.) to a towing vehicle. The apparatus provided has a power unit attached to one end of a flexible material line. At the opposite end of this line is a member designed to engage a complimentary member mounted on the towing vehicle. The line passes through an apparatus designed to govern and direct the energy from the power unit in such a way as to execute complete control of the ranges, degrees and extents of motion of the trailer coupler until it completely encompasses the ball.

### BACKGROUND OF THE INVENTION

This invention facilitates the coupling of towed and towing vehicles. The apparatus is designed to move, elevate, and align a coupler at the forward end of a towed vehicle to a ball on the towing vehicle. It engages the coupler onto the ball with minimal human input and at a greatly reduced cycle time.

To couple towed vehicles to towing vehicles a variety of coupling devices are employed, typically a ball and socket, clevis and pin or pintle and ring. The most common of these is a ball and socket. In this method the towed vehicle (trailer, sled, implement of husbandry, etc.) generally has a forward extending frame at the end of which is a primary coupling device, commonly called the “the socket” or the “coupler”. The towing vehicle has a complementary secondary coupling device, commonly call the “ball”. The coupler has a cavity in to which to receive and encompass the ball, and when so received connects the two (2) vehicles.

The first and second devices must be connected and disconnected from time to time. Measures of effort and complexity vary within this process. In simplest form, the operator manhandles the forward portion of the towed vehicle “trailer”), pushing it left and right. Lifting it up and setting it down so that the coupler encompasses the ball.

As the scale and mass of the trailer increases, it becomes hazardous and even impossible for the operator to accomplish the task manually. Generally, the weight of the forward section of the trailer at the coupler is approximately 10% to 15% of the gross vehicle weight of the trailer. Weights at the coupler of over 1000 lbs. are not uncommon.

At these higher weights, mechanical means are commonly employed to assist in this task. Jacks are often attached to the trailer frame and activated to elevate the coupler. The ball must then be positioned under the coupler, a seemingly simple action, but varying with the operator's spatial and distal instincts and skill. This method often requires the assistance of a second person. Voice commands and hand signals often exacerbate rather than alleviate the effort. The results are often compromised safety, frustration, strained relations, equipment damage and waste of time. Prior art apparatus is known to aid in the coupling of ball and socket systems.

In U.S. Pat. No. 3,596,925 to Richie, a winch is provided and a winch cable and cable loop extend from the trailer. The cable is passed around a corresponding cable pulley installed at the towing vehicle in the horizontal plane below the ball and returns for connection to the trailer. The cable is guided through a tube beneath the tongue and socket so that as the cable is shortened, the tongue approaches the ball. If initial linear alignment of the towing vehicle and trailer is satisfactory and elevations of the ball and coupler are compatible, the coupler is ultimately positioned directly above the ball. This system is not designed to elevate trailer tongues, the pulley is oriented for lateral not vertical movement. Lifting loads result in sharp angles of engagement between the cable and pulley, subjecting the cable to high stresses and damage to the cable, guide tube and pulley.

In U.S. Pat. No. 5,085,408 to Norton, a winch system is used to draw the coupler toward the ball on the horizontal plane. No method of securing control of the positional relationship between the coupler and ball is provided. Additional apparatus and effort are required to actually engage the coupler onto the ball.

In U.S. Pat. No. 5,938,227 to Hills, a winch cable driven system is used which reduces cable damage by modifying both the ball and the coupler. A cable is passed upward through a hole formed in the ball and terminates inside the coupler. The cable rides over a small pulley installed in the ball, located within its spherical profile. When the cable is winched from the tow vehicle, the trailer's coupler is drawn to the ball. The cable lifts and finally draws the coupler onto the ball. This system is complex and requires significant modifications to known couplings; requiring a custom ball and coupler to accommodate the cable and it interferes with the structural integrity of both ball and coupler.

In U.S. Pat. No. 5,405,160 to Weaver, a substantially flat strap is attached to a winch mounted on the trailer frame. The line passes from the winch forward and underneath a roller, which is mounted at the end of a movable arm. The line has at its end, a flat attachment member with an aperture of sufficient size to encompass the base of the ball. When the movable arm is positioned for use and locked into place, the strap is extended to the ball and attached to it. The winch is then activated, pulling the trailer toward the ball. The coupler elevates as it moves forward toward the ball. In the absence of forces along the transverse or longitudinal axis, the coupler comes into position directly above the ball. As the winch strap is extended, the coupler may settle over the ball. The arm can then be repositioned for transport. This system, is relatively simple but because the coupler is some distance above the ball when the winch strap is released there is a significant probability of lateral motion as the coupler descends. The goal is accomplished only when conditions are ideal. Difficulty arises when there are any irregularities because of the vertical distance the coupler is from the ball when the winch strap becomes released.

If the trailer wheels encounter any surface irregularity as they roll forward (depressions, ruts, soft ground, or any object) or if the right and left sides or front or back of the trailer are at different elevations, a vertical misalignment of the coupler and ball will ensue as the coupler descends toward the ball. The cause of this problem is that the necessary distance the strap must span between the front roller and the attachment member allows the coupler to move on the horizontal plane. Therefore, in this system there is no means of securing the vertical alignment between the coupler and the ball. This often prevents the coupling of the trailer to the ball.

Overall, the historic problem has been to provide an apparatus and method to direct and maintain absolute control of the first coupling device until final and complete connection is made to the second coupling device.

### BRIEF SUMMARY OF THE INVENTION

This invention addresses and overcomes the problems of coupling a trailer to a towing vehicle in a manner not addressed by prior art. It accomplishes this by providing several novel mechanical elements and methodologies. With respect to prior art, the problem of exercising absolute control of the coupling devices as they are brought into secured connection and, thereafter, controlled disconnection have not been fully addressed. In order to forcibly align and engage the coupling devices with precision and certainty, all three axis of motion of the trailer coupler must be controlled, not merely influenced. Various examples of prior art have achieved only limited degrees of success in satisfying the elements of this goal. This invention accomplishes the entire goal in the following manner:

A—Implementing three stages of operation for connection.

1. Drawing the coupler up and toward the ball with a flexible, tensional powered line, establishing a horizontally fixed positional relationship between the connecting members by providing a pivotal point of contact between two of the invention's components (an anchor and anchor-tab).

2. Continuing to apply tension to the flexible line, which retracts the telescopic member, and allows the tension to be applied to moving the coupler forward towards the ball on a horizontal plane. This brings the coupler into a precise, mechanically secured, vertical alignment over the ball.

3. Releasing tension from the flexible line, allowing gravity to draw the coupler down, and encompass the ball.

B—Implementing three stages of operation for disconnection.

1. Applying tension to the line, exerting a vertical force in opposition to gravity to lift the coupler off the ball.

2. Disengaging a mechanical lock to release the energy from the telescoping member to push the coupler backward from the ball in a horizontal plane.

3. Lowering the coupler to its original elevation.

A novel aspect of this invention is the method of governing and directing the energy from the power unit through the flexible line, to the towing vehicle's coupling member. The invention utilizes a coiled compression spring in the preferred embodiment, to provide a biased resistance on an integral telescoping or extending member. This resistance delays the retraction of this member until a pivotal point of contact is established between two of the inventions components-namely the “anchor-tab” and the telescoping member. At this critical stage, the spring begins to compress, allowing the telescoping member to travel inward. The positional relationship between the telescoping member and the coupler is fixed on the vertical axis and is confined on the horizontal axis to one linear path (the vector of travel of the telescopic member). When the apparatus is properly mounted, the coupler “zeros in” directly over the ball in a controlled and precise manner.

The main objective of this invention is to provide a novel, unique and improved apparatus for mechanically engaging a towing vehicle to a trailer and thereafter disengaging the trailer from the towing vehicle.

Additional objectives of this invention in concert with the main objective are:

To provide an apparatus and method of pulling a trailer to a towing vehicle using one of a variety of power units.

To provide an apparatus and method of mechanically engaging a trailer to a towing vehicle wherein the trailer engagement member is precisely and automatically aligned with the towing vehicle engagement member.

To provide an apparatus and method of mechanically engaging a trailer to a towing vehicle wherein the spacial relationship between the two engagement members is secured or “locked in” prior to engagement.

To provide an apparatus and method of mechanically engaging a trailer to a towing vehicle wherein the engagement members may be of a variety of mechanical designs.

To provide an apparatus and method of mechanically engaging a trailer to a towing vehicle wherein the operator is essentially remotely located, thus not physically involved in the dynamic aspects of operation, ensuring human safety.

### BRIEF DESCRIPTION OF THE SEVERAL VIEWS OF THE DRAWING

FIG. 1 is a side elevation (showing hidden lines) of a first embodiment of an apparatus designed to couple a trailer to a towing vehicle.

FIG. 2 is a side elevation (suppressing hidden lines) of the same apparatus.

FIG. 3 is an isometric view of an element of the invention referred to as the “anchor tab”.

FIG. 4 is an isometric view of an element of the invention refereed to as the “anchor”.

FIG. 5 is an isometric view of the anchor lodged in the anchor tab.

FIG. 6 is a sequential representation of the invention in use.

FIG. 7 is an isometric view of the sleeve and telescoping member from the bottom. It shows the locking apparatus for confining the spring's energy.

FIG. 8 is an isometric view from the bottom showing the apparatus in “locked” position.

FIG. 9 is an orthographic side elevation of the optional spool sheave (20).

### DETAILED DESCRIPTION OF THE INVENTION

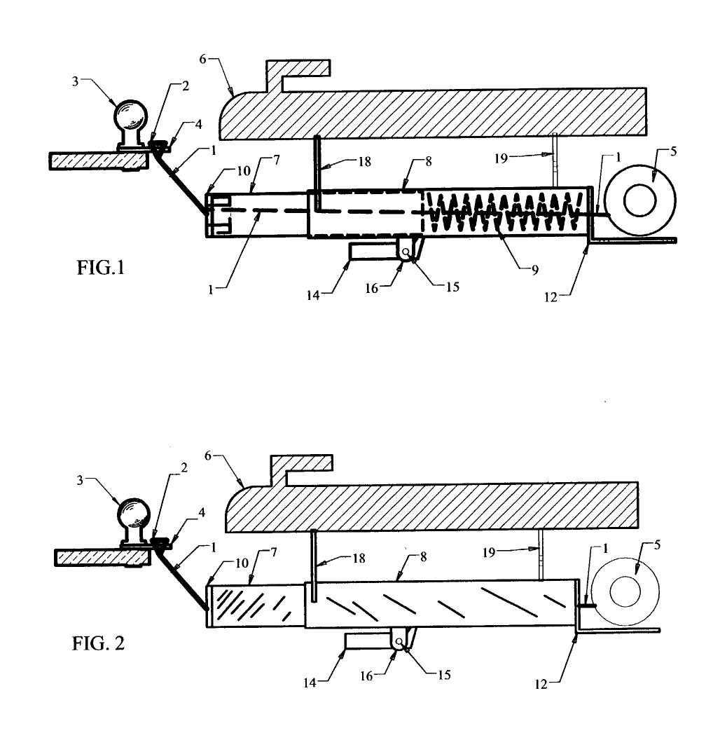

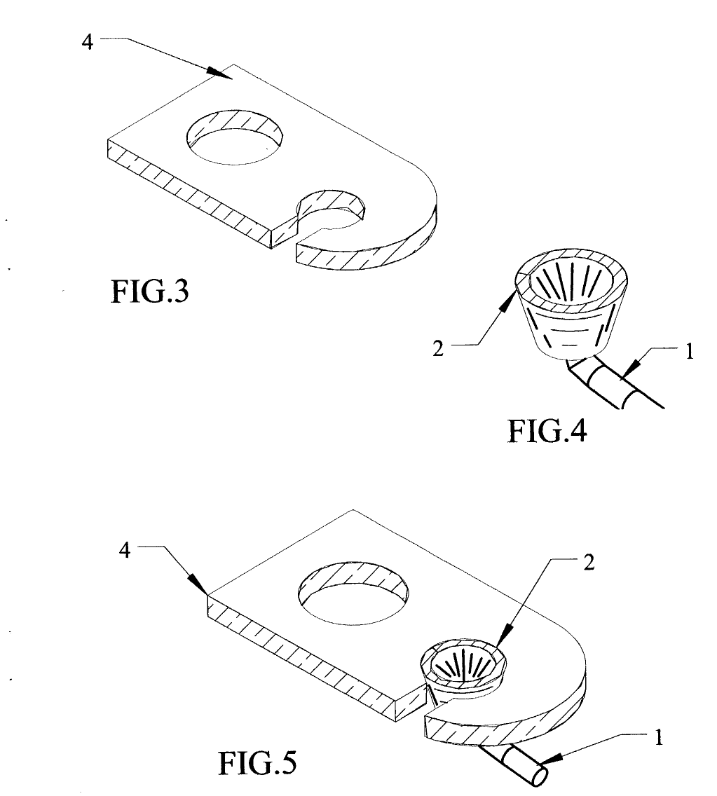

The invention has a flexible line 1 of material of sufficient tensile strength (FIG. 1). The line 1 is attached at one end to the towed vehicle and at the other end to an anchoring device 2, the “anchor” 2. Line 1 provides a means of pulling the trailer to the towing vehicle. The anchor 2 can be a truncated cone, spherical or thimble shaped member (FIG. 4) of any material of sufficient strength. It is designed to receive within its profile into its smaller end a knotted or swedged end of the flexible line 1. The towing vehicle has attached, adjacent to its coupling member 3 (usually the ball), an apparatus 4 (FIG. 4) designed to receive the anchor 2. This apparatus 4 is mounted in a fixed positional relationship to the ball 3 (FIGS. 1 and 2) and is hereinafter refereed to as the “anchor tab” 4. Anchor tab 4 may be a flat steel (or similar material) member of approximately the same width as the existing portion of the towing vehicle on which the ball 3 is mounted. It has towards its one end an aperture of sufficient size to allow the threaded portion of the ball 3 to pass through with normal clearance (FIG. 3). Towards the other end, of anchor tab 4 is a keyhole shaped aperture (FIG. 3) of sufficient size to receive the smaller diameter of the anchor 2 without allowing the larger diameter of anchor 2 to pass through.

The opposite end of the line 1 may be attached to the towed vehicle by a pulling mechanism 5, whether a winch or other source of motive power hereinafter referred to as the “power unit” 5, usually mounted on the trailer below and behind the coupler 6 (FIGS. 1 AND 2). Hydraulic, pneumatic or gas cylinders or motors, or rack and pinion arrangements may alternatively be used. Pulleys or sheaves designed to receive motive power from a towing vehicle or other remote location may also be employed. These alternate methods would not deviate from the principles of the invention.

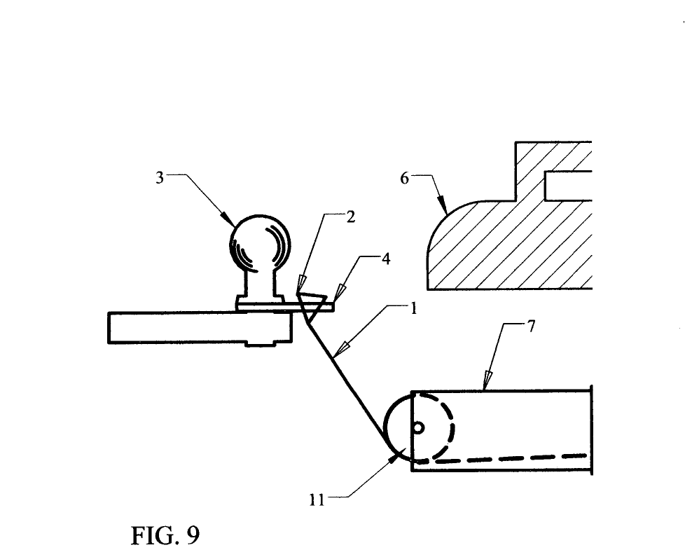

Between the anchor 2 device and the power unit 5 exists the main body of the invention (FIGS. 1 and 2). It is comprised of the following elements: a telescopic member 7 being a length of hollow metallic type material sliding partially into one end of a sleeve 8, being another length of hollow metallic type material, of sufficiently larger inside dimension than the telescopic member 7 so that the telescopic member can freely slide within the sleeve 8 without any undue vertical or horizontal movement, other than into and out of the length of the sleeve 8. Sleeve 8 is of such length that it will contain both the majority of the length of the telescoping member 7 and a coiled compression spring 9. The telescoping member 7 has at one end affixed a bushing 10 with an aperture in its center, or alternately a spool sheave 11 (FIG. 9), through or under which passes the line 1. This member 10 or 11 guides the line 1 and brings the telescoping member 7 into contact with the anchor tab 4. The opposite end of this telescopic member 7 comes into contact with the end of the coiled compression spring 9, positioned inside the sleeve 8. The line 1 passes through the axial center of the spring 9. At the rearward end of the sleeve 8 is affixed another metallic member 12, with an aperture through which the line 1 passes. It is mounted in such a way as to prevent the spring 9 from traveling out from that end of the sleeve 8 and may include a platform to which the power unit 5 may be mounted.

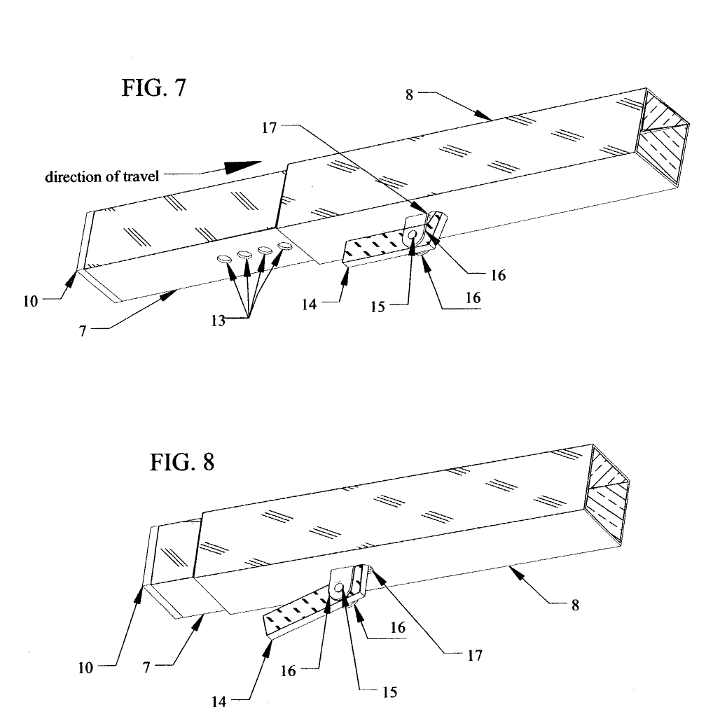

Along the underside of the telescoping member 7, a number of holes 13 are positioned in a linear manner along a longitudinal axis to be able to receive a pin 14 (FIG. 7). This pin 14 mounts in a hinge assembly consisting of a cross pin 15, and a set of pin tabs 16 on the underside of the sleeve 8 (FIGS. 7 AND 8). The engagement end of the pin 14 travels perpendicularly through a single hole 17 positioned near one end and underside of the sleeve 8 (FIGS. 7 and 8). The pin 14 is such that one end is heavier than the other end which fits through the hole 17. It is positioned so that as gravity affects the heavier (handle) end of pin 14, the lighter end travels up, through the hole in the sleeve 17 and into any of the holes 13 in the telescoping member 7. The lighter end of pin 14 is angled so that as telescopic member 7 moves into sleeve 8 the pin will slide from one hole 13 to another hole 13 but lock into a hole 13 when telescopic member 7 moves in the opposite direction. The purpose of these holes 13 and 17 and pin 14 is to provide a means of locking the telescoping member 7 inside the sleeve 8 thus confining the energy of the spring 9 at the appropriate stage in the apparatus's range of motion. A number of other methods are also available to execute this function. Cam locks, friction devices, detent balls and pins alternatively may be employed. These alternatives do not deviate from the principles of the invention. The described apparatus may be mounted to the trailer frame and coupler 6 with conventional bracketry 18 and 19 in a substantially horizontal orientation (FIGS. 1 and 2), parallel to the trailer frame. All the structural components between the power source 5 and the anchor 2 are hollow or have void areas provided for the passage of the line 1. When not in use, pressure of the spring 9 is relaxed.

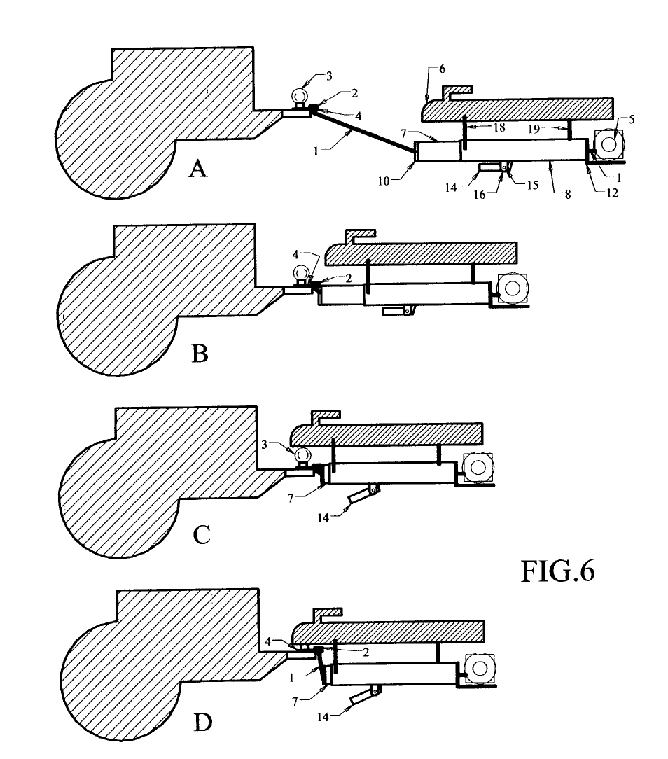

To secure the towing vehicle to the trailer, the operator extends the (flexible member) line 1 toward the ball 3 and connects its anchor 2 to the anchor tab 4 (FIG. 6-A). The power unit 5 is activated and a tension load is placed on the line 1, bringing the coupler 6 toward the ball 3. The operator observes the coupler 6 approach and ascend toward the ball 3. When the front of the telescoping member 7 comes into contact with the anchor tab 4 (FIG. 6-B), the coupler 6 will be positioned above and behind the ball 3. At this point, the telescoping member 7 begins to move into the sleeve 8 and compress the spring 9 allowing the coupler 6 to travel forward and over the ball 3 with an absolute minimum of vertical clearance (FIG. 6-C). As the center of the coupler 6 moves towards the ball 3 the pin 14 slides from hole 13 to hole 13 (FIG. 7). When the center of the cavity of coupler 6 is vertically aligned over the center of the ball 3, the pin 14, on the sleeve 8 will be in or near a hole 13 of telescoping member 7. When the operator observes this action, he/she will extend the line 1, relaxing its tension. The telescoping member 7 may move a short distance until the pin 14 locks into a hole 13 if it is not in such a hole 13. The energy from the spring 9 is now contained in the sleeve 8 and is unable to affect the line 1. The natural physical result is that gravity brings the coupler 6 downward (FIG. 6-D) so that its cavity can completely encompass the ball 3. It cannot deviate from side to side or forward or backward, as there is insufficient clearance between the top of the ball 3 and bottom of the coupler 6 to allow for such deviation (FIG. 6-C). mechanism 13, 14, 15, 16 and 17 has automatically activated, all ranges and degrees of motion are secured. When line 1 is extended, gravity lowers the coupler 6 on to ball 3.

I claim:

1. An apparatus and method for attaching a trailer having a first hitch portion to a vehicle having a second hitch portion comprising:
a) a connection means for connecting the trailer and the vehicle;
b) a pulling means, attached to the connection means for tensioning and shortening the length of the connection means between the trailer and the vehicle; and
c) a resisting pressure means which creates pressure between the trailer and the vehicle as the connection means is shortened.

2. The apparatus in claim 1 in which the connection means is a flexible line.

3. The apparatus in claim 1 in which the pulling means is a winch.

4. The apparatus in claim 1 wherein the connection means includes an anchor means for attaching the connection means to the vehicle.

5. The apparatus in claim 4 wherein the anchor means is a conical means having the connection means attached to the smaller end of the conical means.

6. The apparatus in claim 4 in which the vehicle has attached an anchor tab means for the purposes of attaching the anchor means.

7. The apparatus in claim 6 in which the anchor tab means is an elongated flat metal means having a fastening means towards one end for attaching the anchor tab means to the vehicle and an aperture means towards the other end for attaching the connection means to the anchor tab means.

8. The apparatus in claim 7 in which the fastening means is a hole through which a protrusion in the vehicle can be inserted.

9. The apparatus in claim 7 in which the fastening means is a hole through which a cylindrical means can be inserted to attach the anchor tab means to the vehicle.

10. The apparatus in claim 9 in which the cylindrical means is a bolt screwed into the vehicle.

11. The apparatus in claim 9 in which the cylindrical means is the base of the ball of a ball and socket trailer coupling system.

12. The apparatus in claim 1 in which the resisting pressure means is a telescoping member means which slides into and out of a receiving member means and encounters resistance to such movement by a resistance means.

13. The apparatus in claim 12 in which the telescoping member means encounters resistance from the resistance means as it moves into the receiving means.

14. The apparatus in claim 13 in which the resistance means is a compression spring contained within the receiving member means.

15. The apparatus in claim 12 in which the movement of the telescoping member means can be arrested by a locking means.

16. The apparatus in claim 15 in which the locking means is a pin means attached to the receiving member means by a hinge assembly and which arrests the movement of the telescoping member means through a hole in the receiving member means.

17. The apparatus in claim 16 in which the pin means locks into one of a series of holes in the telescoping member means.

18. The apparatus in claim 16 in which the pin means is at the bottom side of the receiving member means.

19. The apparatus in claim 12 in which the connection means travels through the resisting pressure means.

20. The apparatus in claim 19 in which a bushing, through which the connection means can enter the resisting pressure means, is at the exterior end of the telescoping member means.

21. The apparatus in claim 19 in which a spool sheave, under which the connection means can enter into the resisting pressure means, is at the exterior end of the telescoping member means.

22. A method of attaching a trailer having a first hitch portion to a vehicle having a second hitch portion, comprising the steps of:
a) connecting the said trailer to the said vehicle with a connection means;
b) engaging the pulling means to increase the tauntness of the connection means there by reducing the length of the connection means and pulling the said trailer to the said vehicle and locating the first hitch portion above the second hitch portion.
c) disengaging the pulling means to release the tautness of the connection means thereby allowing the first hitch portion to engage with the second hitch portion.

23. A method of detaching a trailer having a first hitch portion from a vehicle having a second hitch portion comprising the steps of:
a) engaging the pulling means to increase the tautness of the connection means thereby raising the first hitch portion immediately above the second hitch portion;
b) disengaging the locking means to permit the resisting pressure means to provide pressure to lengthen the connection means;
c) disengaging the pulling means to allow the resisting pressure means to lengthen the connection means thereby moving the first hitch portion away from the second hitch portion.
